(19) United States
(12) Patent Application Publication
(10) Pub. No.: US 2026/0313080 A1
(43) Pub. Date: Oct. 8, 2026

(54) PROJECTION METHOD, PROJECTION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventors: Naoki SUZUKI, MATSUMOTO-SHI (JP); Shingo WAKIMOTO, AZUMINO-SHI (JP); Shoichi KINOSHITA, BEPPU-SHI (JP)

(21) Appl. No.: 19/462,008

(22) Filed: Jan. 28, 2026

(30) Foreign Application Priority Data
Jan. 29, 2025 (JP) 2025-013185

(51) Int. Cl. H04N 9/31

(52) U.S. Cl. CPC H04N 9/3194; H04N 9/3179; H04N 9/3129

(57) ABSTRACT

A projection method, by a processor of a projection apparatus, includes: executing a first determination of determining whether it is a state where an object is present between a projector that projects image light having a first brightness on a projection surface and the projection surface; executing a first control of controlling the projector to change the brightness of the image light from the first brightness to a second brightness lower than the first brightness, when it is determined that it is the state where the object is present, based on a result of the first determination; and executing a second control of controlling the projector to change the brightness of the image light from the second brightness to the first brightness after a lapse of a first period, when it is determined that the state changes from the state where the object is present to a state where the object is not present, based on the result of the first determination.

The present application is based on, and claims priority from JP Application Serial Number 2025-013185, filed Jan. 29, 2025, the disclosure of which is hereby incorporated by reference herein in its entirety.

### BACKGROUND

### 1. Technical Field

The present disclosure relates to a projection method, a projection apparatus, and a non-transitory computer-readable storage medium storing a program.

### 2. Related Art

According to the related art, a projection device having an anti-glare function is known.

For example, a projection display device disclosed in JP-A-2000-305481 picks up an image of a display area by an image pickup unit and detects position information of a person located in the display area. The projection display device determines a luminance adjustment area of video light from the detected position information of the person, and adjusts the luminance of the video light in the determined luminance adjustment area.

JP-A-2000-305481 is an example of the related art.

The projection display device disclosed in JP-A-2000-305481 cancels the anti-glare function when it is determined that the person is no longer present in the display area. In the projection display device, an image pickup unit including a CCD sensor is disclosed, but a phenomenon in which the anti-glare function repeatedly turns on and off may occur due to characteristics of the CCD sensor. When the anti-glare function repeatedly turns on and off in a short time, a person may recognize this as flickers of image light and may feel uncomfortable.

### SUMMARY

According to an aspect of the present disclosure, a projection method includes: by one or a plurality of processors, executing a first determination of determining whether it is a state where an object is present between a projector that projects image light having a first brightness on a projection surface and the projection surface, based on an output of a first sensor; executing a first control of controlling the projector to change the brightness of the image light from the first brightness to a second brightness lower than the first brightness, when it is determined that it is the state where the object is present, based on a result of the first determination; and executing a second control of controlling the projector to change the brightness of the image light from the second brightness to the first brightness after a lapse of a first period, when it is determined that the state changes from the state where the object is present to a state where the object is not present, based on the result of the first determination.

According to another aspect of the present disclosure, a projection apparatus includes a projector that projects image light having a first brightness on a projection surface, based on an output of a first sensor, the first sensor, and one or a plurality of processors, and the one or plurality of processors execute: a first determination of determining whether it is a state where an object is present between the projector that projects the image light having the first brightness on the projection surface and the projection surface, based on the output of the first sensor; a first control of controlling the projector to change the brightness of the image light from the first brightness to a second brightness lower than the first brightness, when it is determined that it is the state where the object is present, based on a result of the first determination; and a second control of controlling the projector to change the brightness of the image light from the second brightness to the first brightness after a lapse of a first period, when it is determined that the state changes from the state where the object is present to a state where the object is not present, based on the result of the first determination.

According to still another aspect of the present disclosure, a non-transitory computer-readable storage medium storing a program is provided, and the program causes one or a plurality of processors provided in a projection apparatus to execute: a first determination of determining whether it is a state where an object is present between a projector that projects image light having a first brightness on a projection surface and the projection surface, based on an output of a first sensor; a first control of controlling the projector to change the brightness of the image light from the first brightness to a second brightness lower than the first brightness, when it is determined that it is the state where the object is present, based on a result of the first determination; and a second control of controlling the projector to change the brightness of the image light from the second brightness to the first brightness after a lapse of a first period, when it is determined that the state changes from the state where the object is present to a state where the object is not present, based on the result of the first determination.

### BRIEF DESCRIPTION OF THE DRAWINGS

FIG. 1 is a block diagram showing the configuration of a projection apparatus.

FIG. 2 shows the configuration of a projector.

FIG. 3 shows a state where a user stands in front of a projection surface.

FIG. 4 shows a measurement range of a distance sensor and a pixel as a unit of measurement.

FIG. 5 shows the positional relationship between the projection surface and an object.

FIG. 6 shows an example of a guide screen displayed on a projection surface 30.

FIG. 7 is a flowchart showing an operation of a controller.

### DESCRIPTION OF EMBODIMENTS

### 1. Configuration of Projection Apparatus

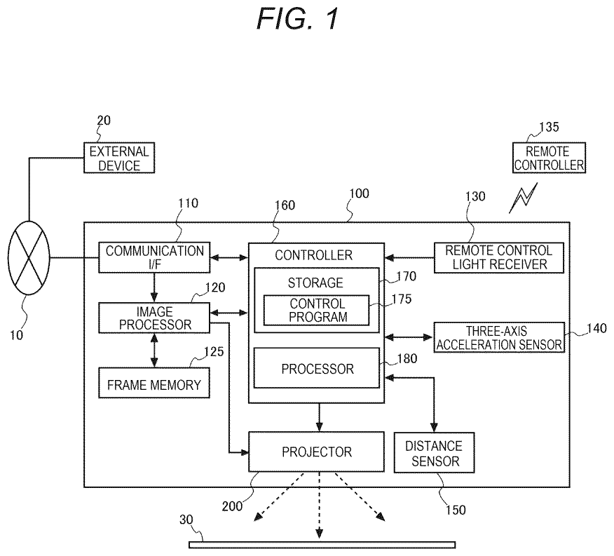

FIG. 1 is a block diagram showing the configuration of a projection apparatus 100.

The projection apparatus 100 is connected to an external device 20 via a network 10. The projection apparatus 100 receives image data supplied from the external device 20 via the network 10, generates image light corresponding to the received image data, and projects the generated image light on a projection surface 30.

The external device 20 is, for example, a laptop, desktop, or tablet personal computer. A smartphone may be used as the external device 20.

A wall surface, a ceiling, a screen, or the like of a room in which the projection apparatus 100 is installed is used as the projection surface 30. An outer wall or the like of a building or the like may be used as the projection surface 30.

Although FIG. 1 shows the case where the projection apparatus 100 is wired to the network 10, the projection apparatus 100 may be wirelessly connected to the network 10. Also, the projection apparatus 100 and the external device 20 may be directly connected by a wire or wirelessly.

The projection apparatus 100 includes a communication interface 110, an image processor 120, a frame memory 125, a remote control light receiver 130, a three-axis acceleration sensor 140, a distance sensor 150, a projector 200, and a controller 160. Hereinafter, the interface is abbreviated as an I/F.

The first communication I/F 110 includes, for example, a communication card such as a network interface card (NIC), and performs data communication with the external device 20 via the network 10. The communication I/F 110 receives image data from the external device 20 and outputs the received image data to the image processor 120. While FIG. 1 shows an example in which the communication I/F 110 is wired to the network 10, the connection between the projection apparatus 100 and the network 10 may be a wireless connection, for example, by Wi-Fi or the like. Wi-Fi is a registered trademark.

The frame memory 125 is coupled to the image processor 120. The frame memory 125 includes a plurality of banks. Each of the banks has a storage capacity in which image data for one frame can be written. The frame memory 125 is, for example, a synchronous dynamic random-access memory (SDRAM). The image processor 120 loads image data input from the communication I/F 110 into the frame memory 125.

The image processor 120 performs image processing on the image data loaded in the frame memory 125. Examples of the image processing performed by the image processor 120 include resolution conversion processing, resizing processing, distortion aberration correction, shape correction processing, digital zoom processing, and adjustment of the tint and luminance of an image. The image processor 120 executes processing designated by the controller 160, and performs processing using a parameter input from the controller 160, as necessary. As a matter of course, the image processor 120 can also execute a combination of a plurality of kinds of image processing, of the above-described kinds of image processing. The image processor 120 reads image data loaded in a bank selected by the controller 160, from the frame memory 125, and outputs the read image data to the projector 200.

The image processor 120 and the frame memory 125 are formed of, for example, an integrated circuit. Examples of the integrated circuit include a large scale integration (LSI), an application-specific integrated circuit (ASIC), a programmable logic device (PLD), a field-programmable gate array (FPGA), a system-on-a-chip (SoC), and the like. A part of the configuration of the integrated circuit may include an analog circuit, and the controller 160 and the integrated circuit may be combined together.

The remote controller light receiver 130 receives an infrared signal transmitted from a remote controller 135. The remote controller 135 includes a plurality of buttons such as a power button, a source switching button, a projection start button, and a projection end button. The remote controller 135 transmits an infrared signal corresponding to a button operated by the user, to the projection apparatus 100. The remote controller light receiver 130 outputs an operation signal corresponding to the received infrared signal to the controller 160. The operation signal is a signal corresponding to the button of the remote controller 135 operated by the user.

The three-axis acceleration sensor 140 is an example of a second sensor and is a sensor that detects a movement and vibration of the projection apparatus 100. When the user moves the position of the projection apparatus 100, the three-axis acceleration sensor 140 detects the movement and vibration of the projection apparatus 100 and outputs measurement data indicating the detected movement and vibration to the controller 160.

The distance sensor 150 is an example of a first sensor and is a ToF (time-of-flight) sensor. The distance sensor 150 irradiates a measurement target with laser light, measures the laser light reflected from the measurement target with an image pickup element, and thus calculates the distance for each pixel. The detection light used by the distance sensor 150 for distance measurement is not limited to laser light, and any of visible light, ultraviolet rays, infrared rays, millimeter waves, and ultrasonic waves may be used. The distance sensor 150 measures the distance to the projection surface 30 or an object such as a person, and outputs measurement data indicating a measurement result to the controller 160.

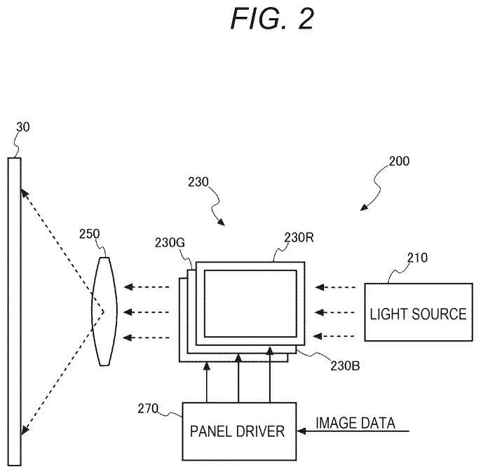

FIG. 2 shows the configuration of the projector 200.

The configuration of the projector 200 will now be described with reference to FIG. 2.

The projector 200 modulates light emitted from a light source 210 to generate image light, and projects the generated image light in an enlarged manner with an optical unit 250. The projector 200 includes the light source 210, three liquid crystal panels 230R, 230G, and 230B as light modulation devices, the optical unit 250, and a panel driver 270. Hereinafter, the liquid crystal panels 230R, 230G, and 230B provided in the projector 200 are collectively referred to as a liquid crystal panels 230.

The light source 210 includes a discharge-type light source lamp such as an ultra-high-pressure mercury lamp or a metal halide lamp, or a solid-state light source such as a light-emitting diode or a semiconductor laser. The light emitted from the light source 210 is separated into red light, green light, and blue light by a color separation system, not illustrated, and becomes incident on the liquid crystal panel 230.

Each of the liquid crystal panels 230R, 230G, and 230B is configured with a transmissive liquid crystal panel formed of a pair of transparent substrates with liquid crystal encapsulated therebetween. The liquid crystal panel 230R modulates red light, the liquid crystal panel 230G modulates green light, and the liquid crystal panel 230B modulates blue light. In each liquid crystal panel, a pixel area including a plurality of pixels arranged in the form of a matrix is formed, and a drive voltage can be applied to the liquid crystal at each pixel.

Image data output by the image processor 120 is input to the panel driver 270. The panel driver 270 applies a drive voltage corresponding to the input image data to each pixel in the pixel region and sets each pixel to a light transmittance corresponding to the image data. The light emitted from the light source 210 is modulated for each pixel by being transmitted through the pixel areas in the liquid crystal panels 230R, 230G, and 230B, and image light corresponding to the image data is thus formed for each color light. The image light of the respective colors, thus formed, are combined for each pixel by a color combining system, not illustrated, and thus form image light of a color image. The optical unit 250 includes, for example, a lens such as a projection lens, and projects the image light modulated by the liquid crystal panels 230R, 230G, and 230B onto the projection surface 30 in an enlarged manner.

Referring back to FIG. 1, the description of the configuration of the projection apparatus 100 will now be continued.

The controller 160 is a computer device including a storage 170 and a processor 180.

The storage 170 includes a random-access memory (RAM) and a read-only memory (ROM). The RAM is used to temporarily store various data. The RAM stores, for example, measurement data output by the distance sensor 150. The ROM stores a control program 175 for controlling an operation of the processor 180 and various setting data.

The processor 180 is an arithmetic processing device including a central processing unit (CPU) or a micro-processing unit (MPU). The processor 180 may be configured with a single processor or may be configured with a plurality of processors. The processor 180 may be configured with a SoC integrated with a part or the entirety of the storage 170 or other circuits. The processor 180 may be configured with a combination of a CPU that executes a program and a digital signal processor (DSP) that executes predetermined arithmetic processing. Moreover, all of the functions of the processor 180 may be implemented in hardware or may be configured using a programmable device.

### 2. Operation of Controller

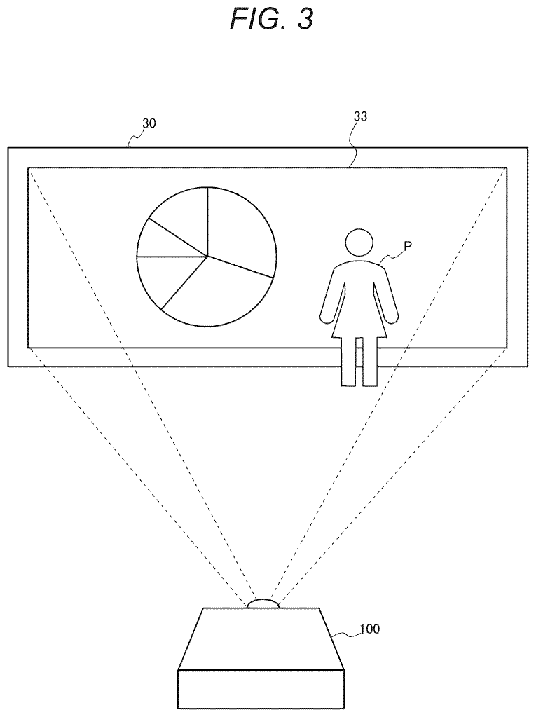

FIG. 3 shows the user standing in front of the projection surface 30.

The projection apparatus 100 has a function of reducing the amount of light incident on the eyes of the user and thus reducing the glare felt by the user. This function is called an anti-glare function.

It is assumed that a user P stands in front of the projection surface 30 in order to point at an image displayed on the projection surface 30. When the user P stands in front of the projection surface 30, the light projected from the projection apparatus 100 becomes incident on the eyes of the user P, and the user P may feel the glare.

Therefore, the controller 160 adjusts the output of the light source 210 or reduces the amount of light transmitted through the liquid crystal panels 230R, 230G, and 230B, based on the measurement data measured by the three-axis acceleration sensor 140 and the distance sensor 150, and thus puts the anti-glare function into operation.

First, the controller 160 executes a second determination of determining whether the projection apparatus 100 is in a stationary state, based on the measurement data of the three-axis acceleration sensor 140. When the controller 160 determines that the projection apparatus 100 is not in the stationary state, based on the measurement data of the three-axis acceleration sensor 140, the controller 160 does not put the anti-glare function into operation even if an object is detected, based on the measurement data of the distance sensor 150.

The projection apparatus 100 has a shape correction function of correcting the shape of an image displayed on the projection surface 30 into a rectangular shape. The shape correction function is executed in real time, each time the user P rotates the projection apparatus 100 in the horizontal direction or moves the projection apparatus 100. In the shape correction, for example, an image is displayed on the projection surface 30 by the projection apparatus 100, an image of a range including the projection surface 30 is picked up by a camera provided in the projection apparatus 100, and the image included in the picked-up image is corrected into a rectangular shape. Therefore, when the brightness of the image light projected by the projector 200 is reduced by the anti-glare function during the execution of the shape correction, the shape correction function may not operate normally. Therefore, when it is determined that the projection apparatus 100 is not in the stationary state, based on the measurement data of the three-axis acceleration sensor 140, the controller 160 does not put the anti-glare function into operation.

Next, when it is determined that the projection apparatus 100 is in the stationary state, based on the measurement data of the three-axis acceleration sensor 140, the controller 160 determines whether an object is detected between the projection apparatus 100 and the projection surface 30, based on the measurement data of the distance sensor 150. The projection apparatus 100 can be rephrased as the projector 200 that projects image light. The object is, for example, a person including the user P of the projection apparatus 100. When an object is detected between the projection apparatus 100 and the projection surface 30, the controller 160 puts the anti-glare function into operation. That is, the controller 160 executes a first control of controlling the projector 200 such that the brightness of the image light projected by the projector 200 changes from a first brightness to a second brightness, which is a reduced brightness. The brightness of the image light when the anti-glare function is in operation is the second brightness, and the brightness of the image light when the anti-glare function is stopped is the first brightness.

However, the user P may feel uncomfortable due to the anti-glare function.

For example, when an object is detected, it is preferable to immediately put the anti-glare function into operation in order to reduce the influence on the human eyes, but when the operation of the anti-glare function is stopped immediately after the anti-glare function operates, the user P may feel that the light source 210 flickers, and the user P may feel uncomfortable.

First, the timing of putting the anti-glare function into operation will be described.

The timing of putting the anti-glare function into operation is set, based on the interval at which the stationary state of the projection apparatus 100 is determined.

For example, it is assumed that the interval at which the controller 160 determines whether the projection apparatus 100 is in the stationary state, based on the measurement data of the three-axis acceleration sensor 140, is 140 msec.

Also, it is assumed that the interval at which the distance sensor 150 outputs the measurement data is 25 msec.

It is also assumed that the anti-glare function is put into operation when an object is detected seven times, based on the measurement data of the distance sensor 150. In this case, the interval is 25 msec ×7, that is, 175 msec, and therefore an interval longer than 140 msec, which is the interval for determining whether the projection apparatus 100 is in the stationary state, can be set. That is, the anti-glare function is put into operation when an object is detected seven times, based on the measurement data of the distance sensor 150, while it is determined that the projection apparatus 100 is in the stationary state twice in succession, based on the measurement data of the three-axis acceleration sensor 140. The interval at which an object is detected seven times, based on the measurement data of the distance sensor 150, is equivalent to a second period.

Next, the timing of stopping the operation of the anti-glare function will be described.

The controller 160 executes a second control of controlling the projector 200 such that the brightness of the image light projected by the projector 200 changes from the second brightness to the first brightness, and thus stops the operation of the anti-glare function.

The timing at which the operation of the anti-glare function is stopped is set, based on the elapsed time from the operation of the anti-glare function or the number of times an object is not detected.

In the present embodiment, the operation of the anti-glare function is stopped, for example, when the object is not detected 80 times, based on the measurement data of the distance sensor 150. Also, the operation of the anti-glare function is immediately stopped when it is determined that the projection apparatus 100 is not in the stationary state, based on the measurement data of the three-axis acceleration sensor 140 during the operation of the anti-glare function.

For example, it is assumed that the time from when the anti-glare function is put into operation to when the operation of the anti-glare function is stopped is 2 sec. The interval at which the distance sensor 150 outputs the measurement data is assumed to be 25 msec. As 80 times are counted based on the measurement data of the distance sensor 150 output at the interval of 25 msec, an interval of at least 2 sec can be set as the interval from when the anti-glare function is put into operation to when the operation is stopped. The interval of 2 sec or 25 msec×80 times is equivalent to a first period. The first period is longer than the second period.

Next, a method for detecting an object, based on the measurement data of the distance sensor 150, will be described.

First, the measurement range of the distance sensor 150 will be described.

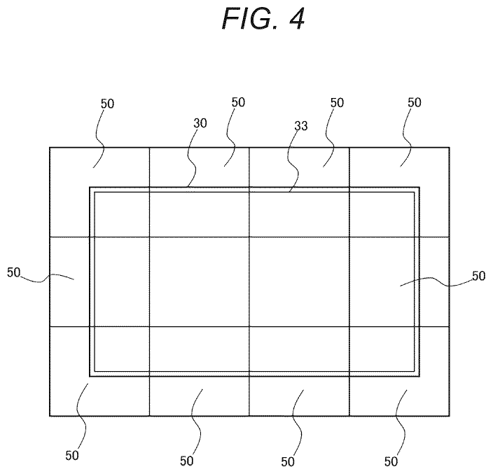

FIG. 4 shows the measurement range of the distance sensor 150 and a pixel as a unit of measurement.

As shown in FIG. 4, the measurement range of the distance sensor 150 is larger than a projection area 33 on the projection surface 30. The projection area 33 is an area where the projector 200 actually projects the image light, on the projection surface 30. While FIG. 4 shows the case where the measurement range of the distance sensor 150 is larger than the projection area 33, the projection area 33 may be larger than the measurement range of the distance sensor 150, depending on the throw ratio of the projection lens. The throw ratio indicates the ratio between the distance from the projection apparatus 100 to the projection surface 30 and the lateral width of the image projected on the projection surface 30.

The distance sensor 150 measures the distance for each pixel serving as a unit of measurement, and outputs measurement data indicating a measurement result. The distance sensor 150 in the present embodiment is a ToF camera having a low resolution of three vertically arranged pixels by four horizontally arranged pixels, as viewed in the illustration. A pixel provided in the ToF camera is referred to as a ToF pixel 50. The distance sensor 150 measures the distance every 25 msec, for example, and outputs measurement data indicating the measurement result to the controller 160. The measurement data is data indicating the measurement result of the distance for each of the ToF pixels 50.

The controller 160 stores the measurement data input from the distance sensor 150, in the storage 170. The storage 170 stores eight pieces of measurement data. One piece of measurement data is referred to as one frame. For example, the storage 170 stores measurement data for eight frames F0, F1, F2, F3, F4, F5, F6, and F7. The measurement data having the longest elapsed time from the measurement is F0, and the measurement data having the shortest elapsed time from the measurement is F7.

For example, when newly measured measurement data F8 is input, the controller 160 deletes the measurement data of F0 from the storage 170 and stores the measurement data F8 in the storage 170.

Next, a method for detecting an object, based on the measurement data, will be described.

For example, it is assumed that measurement data for the eight frames F0, F1, F2, F3, F4, F5, F6, and F7 are stored in the storage 170. The controller 160 sets the measurement data F0, F1, F2, F3 for four frames having a long elapsed time from the measurement, as background data, and sets the measurement data F4, F5, F6, F7 for four frames having a short elapsed time from the measurement, as detection data. The background data is, for example, data used for measuring the distance from the projector 200 to the projection surface 30 such as a screen. The detection data is data used for detecting the user P entering between the projector 200 and the projection surface 30.

First, the controller 160 finds the average value of the measurement data F0, F1, F2, F3, which are the background data, and the average value of the measurement data F4, F5, F6, F7, which are the detection data, for each ToF pixel 50.

Then, the controller 160 executes a first determination of determining whether an object is present between the projection surface 30 and the projector 200, based on the average value of the background data and the average value of the detection data that are found.

The controller 160 assumes that the average value of the background data is the distance from the distance sensor 150 to the projection surface 30 and that the average value of the detection data is the distance from the distance sensor 150 to the object. The distance from the distance sensor 150 to the projection surface 30 is referred to as a projection surface distance, and the distance from the distance sensor 150 to the object is referred to as an object distance.

Then, the controller 160 determines whether an object is detected, based on the average value of the detection data by the following formula (1).

{(projection surface distance-object distance)/projection surface distance}×100 [%]≥set value (1)

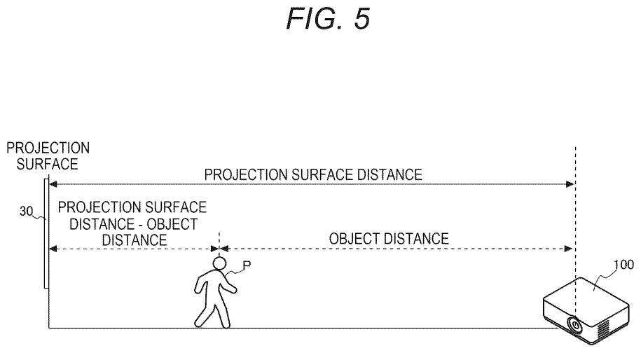

FIG. 5 shows the positional relationship between the projection surface 30 and the object.

When the average value of the detection data satisfies the above formula (1), the controller 160 determines that an object is detected from the detection data. That is, when the user P, who is the object, approaches the projection apparatus 100, the difference between the projection surface distance, which is the numerator in the above formula (1), and the object distance, increases, and the value of the left side of the above formula (1) becomes equal to or greater than the set value, the controller 160 determines that an object is detected.

When the controller 160 detects the object from the detection data, the controller 160 does not update the background data stored in the storage 170 and uses the background data as it is. Specifically, when the measurement data is input every 25 msec, the measurement data having a long elapsed time from the measurement, that is, the background data, is deleted, but when it is determined that an object is detected from the detection data, the background data used for this determination is not deleted from the storage 170 and is used as the background data until the object is no longer detected.

Also, when a value smaller than a preset distance such as 30 cm is detected as the object distance, the controller 160 may immediately put the anti-glare function into operation.

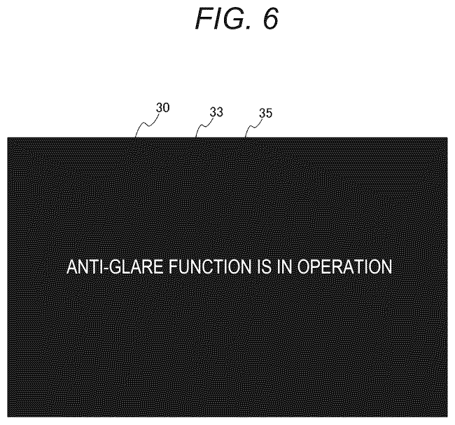

FIG. 6 is a diagram showing an example of a guide screen displayed on the projection surface 30.

When putting the anti-glare function into operation, the controller 160 causes a guide screen 35 to be displayed on the projection surface 30, the guide screen 35 being configured to inform that the anti-glare function is in operation. As illustrated in FIG. 6, in the guide screen 35, a text that informs that the anti-glare function is in operation is displayed in white, and the background of the text is displayed in black with a reduced brightness.

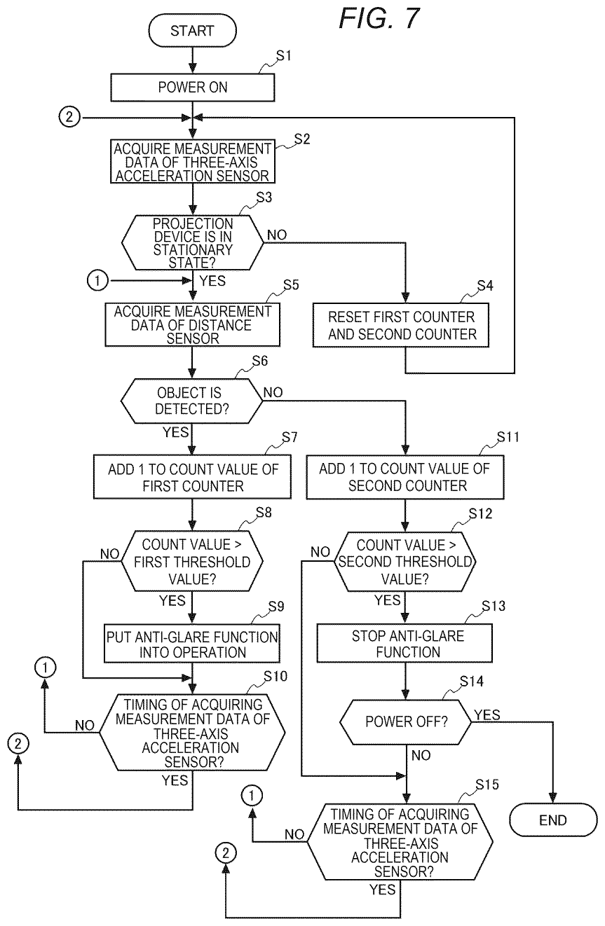

FIG. 7 is a flowchart showing an operation of the controller 160.

The operation of the controller 160 will be described with reference to the flowchart shown in FIG. 7.

In step S1, the controller 160 is activated as the power of the projection apparatus 100 is turned on.

In step S2, the controller 160 acquires the measurement data of the three-axis acceleration sensor 140 from the storage 170. The three-axis acceleration sensor 140 detects an acceleration generated in X-, Y-, and Z-axis directions at regular time intervals, and outputs measurement data including a voltage value corresponding to the detected acceleration to the controller 160. The controller 160 temporarily stores the input measurement data in the storage 170. The controller 160 acquires the measurement data of the three-axis acceleration sensor 140 from the storage 170.

In step S3, the controller 160 determines whether the projection apparatus 100 is in the stationary state, based on the acquired measurement data.

When the projection apparatus 100 is not in the stationary state (NO in step S3), the controller 160 proceeds to the processing of step S4.

When the projection apparatus 100 is in the stationary state (YES in step S3), the controller 160 proceeds to the processing of step S5.

In step S4, when the count values of a first counter or a second counter are not zero, the controller 160 resets the count values of the first counter and the second counter (step S4). The first counter is a counter that counts the number of times an object is detected. The second counter is a counter that counts the number of no-detection times when no object is detected. Then, the controller 160 returns to the processing of step S2.

In step S5, the controller 160 acquires the measurement data of the distance sensor 150 from the storage 170. The distance sensor 150 measures the distance for each ToF pixel 50 at regular time intervals and outputs measurement data indicating the measurement result to the controller 160. The controller 160 temporarily stores the input measurement data in the storage 170. The controller 160 acquires the measurement data of the distance sensor 150 from the storage 170.

In step S6, the controller 160 determines whether an object is detected from the acquired measurement data. The controller 160 calculates the average value of the background data for four frames and the detection data for four frames, for each ToF pixel 50. The controller 160 sets the calculated average value of the background data as the projection surface distance and the average value of the detection data as the object distance, substitutes these values into the above formula (1), and thus determines whether an object is detected.

When an object is detected at at least one of the ToF pixels 50 (YES in step S6), the controller 160 proceeds to the processing of step S7.

Meanwhile, when an object is not detected at any of the ToF pixels 50 (NO in step S6), the controller 160 proceeds to the processing of step S11.

In step S7, the controller 160 adds 1 to the count value of the first counter and proceeds to the determination of step S8.

In step S8, the controller 160 determines whether the count value of the first counter is larger than a first threshold value.

When the count value of the first counter is equal to or less than the first threshold value (NO in step S8), the controller 160 proceeds to the determination of step S10.

When the count value of the first counter is larger than the first threshold value (YES in step S8), the controller 160 proceeds to the processing of step S9.

In step S9, the controller 160 puts the anti-glare function into operation and proceeds to the determination of step S10. The controller 160 controls the projector 200 to put the anti-glare function into operation and proceeds to the determination of step S10. More specifically, the controller 160 puts the anti-glare function into operation by limiting the output of the light source 210 or limiting the amount of light emitted from the liquid crystal panel 230.

In step S10, the controller 160 determines whether it is the timing of acquisition of the measurement data of the three-axis acceleration sensor 140.

When it is the timing of acquisition of the measurement data of the three-axis acceleration sensor 140 (YES in step S10), the controller 160 returns to the processing of step S2. When it is not the timing of acquisition of the measurement data of the three-axis acceleration sensor 140 (NO in step S10), the controller 160 returns to the processing of step S5.

Next, a case where the controller 160 does not detect an object in step S6 will be described.

When an object is not detected (NO in step S6), the controller 160 proceeds to the processing of step S11.

In step S11, the controller 160 adds 1 to the count value of the second counter and proceeds to the determination of step S12.

In step S12, the controller 160 determines whether the count value of the second counter is larger than a second threshold value.

When the count value of the second counter is equal to or less than the second threshold value (NO in step S12), the controller 160 proceeds to the determination of step S15.

When the count value of the second counter is larger than the second threshold value (YES in step S12), the controller 160 proceeds to the processing of step S13.

In step S13, the controller 160 stops the operation of the anti-glare function and proceeds to the determination of step S14.

In step S14, the controller 160 determines whether the power of the projection apparatus 100 is turned off. When the power of the projection apparatus 100 is turned off (YES in step S14), the controller 160 ends the processing flow.

When the power of the projection apparatus 100 is not turned off (NO in step S14), the controller 160 proceeds to the determination of step S15.

In step S15, the controller 160 determines whether it is the timing of acquisition of the measurement data of the three-axis acceleration sensor 140. When it is the timing of acquisition of the measurement data of the three-axis acceleration sensor 140 (YES in step S15), the controller 160 returns to the processing of step S2. When it is not the timing of acquisition of the measurement data of the three-axis acceleration sensor 140 (NO in step S15), the controller 160 returns to the processing of step S5.

The above-described embodiment is a preferred embodiment of the present disclosure. However, the present disclosure is not limited to the above-described embodiment, and various modified implementations can be made without departing from the spirit and scope of the present disclosure.

For example, in the above-described embodiment, the case where the liquid crystal panel 230 is provided as the light modulation device is described, but the liquid crystal panel 230 may be a transmissive liquid crystal panel 230 or a reflective liquid crystal panel 230. The light modulation device may have a configuration in which a digital mirror device is used instead of the liquid crystal panel 230. The light modulation device may have a configuration in which a digital mirror device and a color wheel are combined together. As the light modulation device, a configuration that can modulate the light emitted by the light source may be adopted other than the liquid crystal panel 230 and the digital mirror device.

The functional units of the projection apparatus 100 illustrated in FIG. 1 represent functional components, and the specific implementation forms of the functional units are not particularly limited. That is, hardware individually corresponding to the functional units does not always need to be implemented, and as a matter of course, a configuration in which one processor executes a program to implement functions of a plurality of functional units may be adopted. A part of the functions implemented by software in the embodiment may be implemented by hardware or a part of the functions implemented by hardware in the embodiment may be implemented by software. In addition, the specific detailed configurations of the other parts of the projector can also be freely changed without departing from the spirit and scope of the present disclosure.

The processing elements in the flowchart illustrated in FIG. 7 are provided by dividing the processing according to the main processing contents in order to facilitate the understanding of the processing of the projection apparatus 100. The present disclosure is not limited by the way the processing is divided into the processing elements and the names of the processing elements illustrated in the flowchart of FIG. 7. According to processing contents, the processing of the projection apparatus 100 can also be divided into a larger number of processing elements, and the processing can also be divided such that one processing element includes more processing. The processing order in the above flowchart is not limited to the illustrated example, either.

### 3. Summary of Present Disclosure

A summary of the present disclosure is appended below.

### Appendix 1

A projection method includes: by one or a plurality of processors, executing a first determination of determining whether it is a state where an object is present between a projector that projects image light having a first brightness on a projection surface and the projection surface, based on an output of a first sensor; executing a first control of controlling the projector to change the brightness of the image light from the first brightness to a second brightness lower than the first brightness, when it is determined that it is the state where the object is present, based on a result of the first determination; and executing a second control of controlling the projector to change the brightness of the image light from the second brightness to the first brightness after a lapse of a first period, when it is determined that the state changes from the state where the object is present to a state where the object is not present, based on the result of the first determination.

In the projection method according to Appendix 1, when it is determined by the first determination that the object is present between the projector and the projection surface, the brightness of the image light is changed to the second brightness lower than the first brightness. When the result of the first determination changes from the presence of the object to the absence of the object, the brightness of the image light is changed from the second brightness to the first brightness after the lapse of the first period. Therefore, as compared with when the brightness of the image light is changed from the second brightness to the first brightness immediately after the result of the first determination changes from the presence of the object to the absence of the object, the user can be prevented from recognizing the change as flickers of the image light and therefore the uncomfortableness felt by the user can be reduced.

### Appendix 2

The projection method according to Appendix 1 further includes: executing a second determination of determining whether a projection apparatus including the projector and the one or plurality of processors is in a stationary state, based on an output of a second sensor; and controlling the projector such that the brightness of the image light becomes the first brightness when it is determined by the first determination that the object is present while it is determined by the second determination that the projection apparatus is not in the stationary state.

In the projection method according to Appendix 2, the projector is controlled such that the brightness of the image light becomes the first brightness when it is determined by the first determination that the object is present while it is determined by the second determination that the projection apparatus is not in the stationary state. Thus, even while the user manually moves the projection apparatus, the brightness of the image light projected by the projector does not decrease, and processing such as shape correction can be executed, based on the image light projected on the projection surface by the projector.

### Appendix 3

The projection method according to Appendix 1 further includes executing a second determination of determining whether a projection apparatus including the projector and the one or plurality of processors is in a stationary state, based on an output of a second sensor, and the executing the first control is executed after a lapse of a second period, when it is determined by the second determination that the projection apparatus is in the stationary state and it is determined by the first determination that the object is present.

In the projection method according to Appendix 3, when it is determined by the second determination that the projection apparatus is in the stationary state and it is determined by the first determination that the object is present, the first control is executed after the lapse of the second period. Therefore, when an object is detected between the projector and the projection surface while the projection apparatus is in the stationary state, the first control is executed.

### Appendix 4

A projection apparatus includes a projector that projects image light having a first brightness on a projection surface, based on an output of a first sensor, the first sensor, and one or a plurality of processors, and the one or plurality of processors execute: a first determination of determining whether it is a state where an object is present between the projector that projects the image light having the first brightness on the projection surface and the projection surface, based on the output of the first sensor; a first control of controlling the projector to change the brightness of the image light from the first brightness to a second brightness lower than the first brightness, when it is determined that it is the state where the object is present, based on a result of the first determination; and a second control of controlling the projector to change the brightness of the image light from the second brightness to the first brightness after a lapse of a first period, when it is determined that the state changes from the state where the object is present to a state where the object is not present, based on the result of the first determination.

In the projection apparatus according to Appendix 4, when it is determined by the first determination that the object is present between the projector and the projection surface, the brightness of the image light is changed to the second brightness lower than the first brightness. When the result of the first determination changes from the presence of the object to the absence of the object, the brightness of the image light is changed from the second brightness to the first brightness after the lapse of the first period. Therefore, as compared with when the brightness of the image light is changed from the second brightness to the first brightness immediately after the result of the first determination changes from the presence of the object to the absence of the object, the user can be prevented from recognizing the change as flickers of the image light and therefore the uncomfortableness felt by the user can be reduced.

### Appendix 5

A non-transitory computer-readable storage medium storing a program is provided, and the program causes one or a plurality of processors provided in a projection apparatus to execute: a first determination of determining whether it is a state where an object is present between a projector that projects image light having a first brightness on a projection surface and the projection surface, based on an output of a first sensor; a first control of controlling the projector to change the brightness of the image light from the first brightness to a second brightness lower than the first brightness, when it is determined that it is the state where the object is present, based on a result of the first determination; and a second control of controlling the projector to change the brightness of the image light from the second brightness to the first brightness after a lapse of a first period, when it is determined that the state changes from the state where the object is present to a state where the object is not present, based on the result of the first determination.

With the program according to Appendix 5, when it is determined by the first determination that the object is present between the projector and the projection surface, the brightness of the image light is changed to the second brightness lower than the first brightness. When the result of the first determination changes from the presence of the object to the absence of the object, the brightness of the image light is changed from the second brightness to the first brightness after the lapse of the first period. Therefore, as compared with when the brightness of the image light is changed from the second brightness to the first brightness immediately after the result of the first determination changes from the presence of the object to the absence of the object, the user can be prevented from recognizing the change as flickers of the image light and therefore the uncomfortableness felt by the user can be reduced.

What is claimed is:

1. A projection method, by one or a plurality of processors, comprising:
executing a first determination of determining whether it is a state where an object is present between a projector that projects image light having a first brightness on a projection surface and the projection surface, based on an output of a first sensor;
executing a first control of controlling the projector to change the brightness of the image light from the first brightness to a second brightness lower than the first brightness, when it is determined that it is the state where the object is present, based on a result of the first determination; and
executing a second control of controlling the projector to change the brightness of the image light from the second brightness to the first brightness after a lapse of a first period, when it is determined that the state changes from the state where the object is present to a state where the object is not present, based on the result of the first determination.

2. The projection method according to claim 1, further comprising:
executing a second determination of determining whether a projection apparatus including the projector and the one or plurality of processors is in a stationary state, based on an output of a second sensor; and
controlling the projector such that the brightness of the image light becomes the first brightness when it is determined by the first determination that the object is present while it is determined by the second determination that the projection apparatus is not in the stationary state.

3. The projection method according to claim 1, further comprising:
executing a second determination of determining whether a projection apparatus including the projector and the one or plurality of processors is in a stationary state, based on an output of a second sensor, wherein
the executing the first control is executed after a lapse of a second period, when it is determined by the second determination that the projection apparatus is in the stationary state and it is determined by the first determination that the object is present.

4. A projection apparatus comprising:
a projector that projects image light having a first brightness on a projection surface, based on an output of a first sensor;
the first sensor; and
one or a plurality of processors, wherein
the one or plurality of processors execute:
a first determination of determining whether it is a state where an object is present between the projector that projects the image light having the first brightness on the projection surface and the projection surface, based on the output of the first sensor;
a first control of controlling the projector to change the brightness of the image light from the first brightness to a second brightness lower than the first brightness, when it is determined that it is the state where the object is present, based on a result of the first determination; and
a second control of controlling the projector to change the brightness of the image light from the second brightness to the first brightness after a lapse of a first period, when it is determined that the state changes from the state where the object is present to a state where the object is not present, based on the result of the first determination.

5. A non-transitory computer-readable storage medium storing a program, the program causing one or a plurality of processors provided in a projection apparatus to execute:
a first determination of determining whether it is a state where an object is present between a projector that projects image light having a first brightness on a projection surface and the projection surface, based on an output of a first sensor;
a first control of controlling the projector to change the brightness of the image light from the first brightness to a second brightness lower than the first brightness, when it is determined that it is the state where the object is present, based on a result of the first determination; and
a second control of controlling the projector to change the brightness of the image light from the second brightness to the first brightness after a lapse of a first period, when it is determined that the state changes from the state where the object is present to a state where the object is not present, based on the result of the first determination.
